(19) United States
(12) Patent Application Publication
(10) Pub. No.: US 2006/0106148 A1
(43) Pub. Date: May 18, 2006

(54) Peroxide cured butyl rubber compositions and a process for making peroxide cured butyl rubber compositions

(76) Inventors: Adam Gronowski, Sarnia (CA); Yong Siak Seow, Singapore (SG); Shunji Baba, Singapore (SG); Rui Resendes, Corunna (CA)

Correspondence Address: LANXESS CORPORATION, 111 RIDC PARK WEST DRIVE, PITTSBURGH, PA, 15275-1112, US

(21) Appl. No.: 10/994,135

(22) Filed: Nov. 19, 2004

(30) Foreign Application Priority Data
Nov. 18, 2004 (CA) 2,488,105

(51) Int. Cl. C08K 3/34

(52) U.S. Cl. 524/492; 524/571; 524/495; 525/332.5; 526/282; 526/336; 526/339

(57) ABSTRACT

The present invention is directed to a peroxide cured rubber composition containing a non-crosslinked or significantly non-crosslinked (<10 wt. % gel) butyl rubber polymer, a multiolefin crosslinking agent, a peroxide curing agent and at least one filler. The present invention is also directed to a process for preparing a peroxide cured rubber composition which includes mixing a non-crosslinked or significantly non-crosslinked butyl rubber with a multiolefin crosslinking agent, at least one filler and a peroxide curing agent, wherein the process does not include the addition of non-peroxide curing agents such as sulfur, quinoids, resins and sulfur donors.

### FIELD OF THE INVENTION

The present invention is directed to a peroxide cured rubber composition containing a non-crosslinked or significantly non-crosslinked (<10 wt. % gel) butyl rubber polymer, a multiolefin crosslinking agent, a peroxide curing agent and at least one filler. The present invention is also directed to a process for preparing a peroxide cured rubber composition which includes mixing a non-crosslinked or significantly non-crosslinked butyl rubber with a multiolefin crosslinking agent, at least one filler and a peroxide curing agent, wherein the process does not include the addition of non-peroxide curing agents such as sulfur, quinoids, resins and sulfur donors.

### BACKGROUND OF THE INVENTION

Butyl rubber (a copolymer of isobutylene and a small amount of isoprene) is known for its excellent insulating and gas barrier properties. In many of its applications butyl rubber is used in the form of cured compounds. Vulcanizing systems usually utilized for this polymer include sulfur, quinoids, resins, sulfur donors and low-sulfur high performance vulcanization accelerators. However, sulfur residues in the compound are often undesirable and promote corrosion of parts in contact with the sulfur cured compound.

Peroxide curable rubber compounds offer several advantages over conventional, sulfur-curing systems. Typically, these compounds display very fast cure rates and the resulting cured articles tend to possess excellent heat resistance and low compression set. In addition, peroxide-curable formulations are much “cleaner” in that they do not contain any extractable inorganic impurities (e.g. sulfur). Such rubber articles can therefore be used, for example, in condenser caps, biomedical devices, pharmaceutical devices (stoppers in medicine-containing vials, plungers in syringes) and possibly in seals for fuel cells. The use of butyl-type rubber is especially preferred for sealing applications because of its non-permeability of gases such as oxygen, nitrogen, etc., and moisture and its stability to acids, alkalis and chemicals.

Co-pending CA Patent Application 2,458,741 discloses the preparation of butyl-based, peroxide curable compounds utilizing novel grades of high isoprene (ca. 5.5-7.5 mol %) butyl rubber. In this application, N,N′-m-phenylenedimaleimide was used as a cure promoter (co-agent). Butyl rubber with a higher than conventional content of isoprene (>2.2 mol %) should be beneficial for applications where free radicals are involved for vulcanization. Rubber Chem. Technol. 42, (1969) 1147-1154, discloses that isoprene units contribute to crosslinking reactions of butyl rubber with peroxides and at the isoprene level in the rubber ca. 3 mol. % the crosslinking and scission reactions balance out.

A commercially available terpolymer based on isobutylene, isoprene and divinylbenzene (DVB), Bayer XL-10000, is curable with peroxides alone. However, this material possesses some disadvantages. Since the DVB is incorporated during the polymerization process, a significant amount of crosslinking occurs during manufacturing. The resulting high Mooney viscosity (ca. 60-75 MU, M_{L}1+8@125° C.) and a very high content of gel (ca. 70-80 wt. %) make this material very difficult to process. Certain modifications in the processing equipment are required during manufacturing this specific rubber grade which involves additional costs.

Accordingly, it would be desirable to have an isobutylene-based polymer which is peroxide curable and completely or almost completely soluble (i.e. gel free).

One of the applications of XL-10000 cured with peroxides is for aluminum electrolytic condenser caps. A material for a condenser cap should have both a high hardness (Shore A>70 units) and a good elongation (≧200%). It is not easy with XL-10000 to satisfy simultaneously these two requirements. Usually, a more soluble XL-10000 gives compounds with a low hardness and a highly insoluble rubber gives compounds with a low elongation. XL-10000 is manufactured so that the solubility limits are controlled (within 20-30 wt. % solubility range) and the “window” for good performance is quite narrow.

It is well known that butyl rubber and polyisobutylene decompose under the action of organic peroxides. Furthermore, U.S. Pat. Nos. 3,862,265 and 4,749,505 disclose that copolymers of a C₄ to C₇ isomonoolefin and up to 10 wt. % isoprene or up to 20 wt. % para-alkylstyrene undergo molecular weight decreases when subjected to high shear mixing. The effect is enhanced in the presence of free radical initiators.

White et al. (U.S. Pat. No. 5,578.682) have previously disclosed a process for preparing a polymer with a bimodal molecular weight distribution derived from a polymer that originally possessed a monomodal molecular weight distribution. The polymer, e.g., polyisobutylene, a butyl rubber or a copolymer of isobutylene and para-methylstyrene, was mixed with a polyunsaturated crosslinking agent (and, optionally, a free radical initiator) and subjected to high shearing mixing conditions in the presence of organic peroxide. This bimodalization was a consequence of the coupling of some of the free-radical degraded polymer chains at the unsaturation present in the crosslinking co-agent. The polyunsaturated crosslinker could contain polyallyl, polyethylenic or polyvinyl unsaturation (e.g. di-or trivinylbenzene). The most preferred crosslinking agents were the di-unsaturated bismaleimides. However, White, et al. is silent about filled compounds of modified polymers or the cure state of such compounds.

Mori et al. (JP 06-172547/1994) discloses a process for crosslinking butyl rubber in the presence of an organic peroxide and a polyfunctional monomer containing an electron-withdrawing group (e.g. ethylene dimethacrylate, trimethylolpropane triacrylate, N,N′-m-phenylene dimaleimide). The product obtained by the process disclosed therein had carbon-carbon bonds at the crosslinking points and therefore considerably improved heat resistance compared to butyl rubbers conventionally cured with sulfur.

Kawasaki et al. (JP 05-107738/1994) describes a partially crosslinked butyl rubber composition capable of providing a cured product having excellent physical properties, heat resistance and low compression set. This composition was achieved by adding a vinyl aromatic compound (e.g. styrene, divinylbenzene) and organic peroxide to regular butyl rubber and partially crosslinking the butyl rubber while applying mechanical shearing force to this blend system. However, Kawasaki, et al. requires in the examples that an additional curing agent such as sulfur, a quinone dioxime or alkylphenol resin was present in the formulation, besides peroxide and DVB.

Surprisingly it has now been found that a composition containing a significantly non-crosslinked (<10 wt. % gel) butyl rubber polymer and DVB can be cured with peroxides alone (i.e. no sulfur, alkylphenol resin or quinine dioxime present). Furthermore, it has now been surprisingly discovered that this significantly non-crosslinked butyl rubber can be cured with peroxides in the presence of divinylbenzene providing compounds with properties equivalent or better than those for vulcanized products based on commercial predominantly crosslinked (70-80 wt. % gel) butyl rubber polymers, Bayer XL-10000, that are cured with peroxide.

### SUMMARY OF THE INVENTION

The present invention is directed to a process for preparing peroxide cured butyl compounds including the steps of mixing a non-crosslinked or significantly non-crosslinked butyl rubber, a multiolefin crosslinking agent, at least one filler and a peroxide curing agent, wherein the process does not include the addition of non-peroxide curing agents such as sulfur, quinoids, resins and sulfur donors.

The present invention is also directed to a peroxide cured butyl compound containing a non-crosslinked or significantly non-crosslinked butyl rubber, a multiolefin crosslinking agent, at least one filler and curing agent containing only peroxides.

The present invention is further directed to vulcanized materials and articles, such as electrolytic condenser caps containing a peroxide cured butyl compound, wherein the MDR and stress-strain characteristics of the vulcanized materials are comparable or better than those of a comparative compound based on a peroxide-curable predominantly crosslinked butyl rubber, Bayer XL-10000.

### BRIEF DESCRIPTION OF THE DRAWINGS

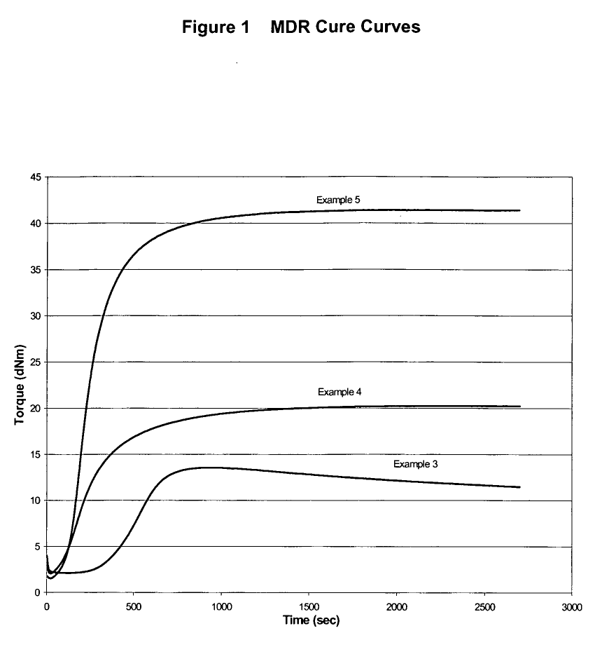

The FIG. 1 illustrates the MDR traces of the compounds prepared according to Examples 3, 4 and 5.

### DETAILED DESCRIPTION OF THE INVENTION

The present invention relates to compounds containing butyl rubber polymers. The terms “butyl rubber”, “butyl polymer” and “butyl rubber polymer” are used throughout this specification interchangeably. While the prior art in using butyl rubber refers to crosslinked or partially crosslinked polymers prepared by reacting a monomer mixture comprising a C₄ to C₇ isomonoolefin monomer and a C₄ to C₁₄ multiolefin monomer and a crosslinking agent, the present invention specifically relates to compounds containing non-crosslinked butyl rubbers (no gel present) containing at least one C₄ to C₇ isomonoolefin monomer and at least one C₄ to C₁₄ multiolefin monomer or compounds containing significantly non-crosslinked butyl rubbers (<10 wt. % gel) containing at least one C₄ to C₇ isomonoolefin monomer and at least one C₄ to C₁₄ multiolefin monomer and less than 0.15 mol % of a multiolefin crosslinking agent. Throughout the specification, “significantly non-crosslinked butyl rubber” is understood to denote a butyl polymer with a gel content below 10 wt. % and containing less than 0.15 mol % of a multiolefin crosslinking agent. The polymers of this invention may include their halogenated analogs, but for specific applications like condenser caps the non-halogenated polymers are preferred.

In connection with the present invention the term “gel” is understood to denote a fraction of the polymer insoluble for 60 minutes in cyclohexane boiling under reflux. According to the present invention the gel content is preferably less than 10 wt. %, more preferably less than 5 wt %, most preferably less that 3 wt % and even most preferably less than 1 wt %.

The non-crosslinked or significantly non-crosslinked butyl rubber of the present invention contains at least one C₄ to C₇ isomonoolefin monomer and at least one C₄ to C₁₄ multiolefin monomer.

The present invention is not restricted to the use of any particular C₄ to C₇ isomonoolefin monomers. Useful C₄ to C₇ monoolefins include isobutylene, 2-methyl-1-butene, 3-methyl-1-butene, 2-methyl-2-butene, 4-methyl-1-pentene and mixtures thereof. For example, the C₄ to C₇ isomonoolefin monomer can be isobutylene.

The present invention is not restricted to the use of any particular multiolefin monomers. Useful monomers include isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, 1-vinyl-cyclohexadiene. According to the present invention the multiolefin content in the butyl rubber is preferably greater than 4.1 mol %, more preferably greater than 5.0 mol %, even more preferably greater than 6.0 mol % and most preferably greater than 7.0 mol %. It should be realized that a considerably higher content of multiolefin in the butyl polymer (for example, exceeding 20 mol %) could negatively affect certain properties typical of butyl rubber, such as impermeability.

Preferably, the monomer mixture contains in the range of from 80% to 95% by weight of at least one isoolefin monomer and in the range of from 5.0% to 20% by weight of at least one multiolefin monomer, based on the weight of the monomer mixture. More preferably, the monomer mixture contains in the range of from 83% to 94% by weight of at least one isoolefin monomer and in the range of from 6.0% to 17% by weight of a multiolefin monomer. Most preferably, the monomer mixture contains in the range of from 85% to 93% by weight of at least one isoolefin monomer and in the range of from 7.0% to 15% by weight of at least one multiolefin monomer.

The monomer mixture for the butyl rubber polymer useful in the present invention may contain minor amounts of one or more additional polymerizable co-monomers. For example, the monomer mixture may contain a small amount of a styrenic monomer like p-methylstyrene, styrene, α-methylstyrene, p-chlorostyrene, p-methoxystyrene, indene (including indene derivatives) and mixtures thereof. If present, the styrenic monomer can be used in an amount of up to 5.0% by weight of the monomer mixture. The values of the C₄ to C₇ isomonoolefin monomer(s) and C₄ to C₁₄ multiolefin monomer(s) will have to be adjusted accordingly to result in a total of 100% by weight.

According to the present invention, the monomer mixture used to prepare substantially non-crosslinked butyl rubber can contain up to 1% by weight of at least one multiolefin crosslinking agent. The values of the C₄ to C₇ isomonoolefin monomer(s) and C₄ to C₁₄ multiolefin monomer(s) will have to be adjusted accordingly to result in a total of 100% by weight of the monomer mixture.

According to the process of the present invention, a butyl rubber polymer can be prepared in the absence of crosslinking agents or curing agents and subsequently the non-crosslinked butyl rubber polymer can be mixed with a crosslinking agent and a peroxide curing agent and at least on filler. Further according to the present invention, a peroxide cured rubber composition can be prepared with a butyl rubber polymer, a crosslinking agent (like DVB) and a peroxide curing agent, without any presence of non-peroxide curing agents such as sulfur, quinoids, resins and sulfur donors.

The present invention is not restricted to any particular multiolefin cross-linking agent. Preferably, the multiolefin cross-linking agent is a multiolefinic hydrocarbon compound. Examples include norbornadiene, 2-isopropenylnorbornene, 5-vinyl-2-norbornene, 1,3,5-hexatriene, 2-phenyl-1,3-butadiene, divinylbenzene, diisopropenylbenzene, divinyltoluene, divinylxylene or C₁ to C₂₀ alkyl-substituted derivatives of the above compounds. More preferably, the multiolefin crosslinking agent is divinylbenzene, diisopropenylbenzene, divinyltoluene, divinylxylene or C₁ to C₂₀ alkyl substituted derivatives of said compounds. Most preferably the multiolefin crosslinking agent is divinylbenzene or diisopropenylbenzene. The peroxide cured rubber composition according to the present invention contains the multiolefin crosslinking agent in the amount of from 1 to 25 phr, preferably 2 to 20 phr, more preferably, 3 to 15 phr.

The use of even other monomers in the butyl rubber polymer is possible, provided, of course, that they are copolymerizable with the other monomers in the monomer mixture.

The present invention is not restricted to a special process for preparing/polymerizing the monomer mixture to produce the butyl rubber polymer. This type of polymerization is well known to the skilled in the art and usually includes contacting the monomer mixture described above with a catalyst system. The polymerization can be conducted at a temperature conventional in the production of butyl polymers—e.g., in the range of from −100° C. to +50° C. The polymer may be produced by polymerization in solution or by a slurry polymerization method.

Polymerization can be conducted in suspension (the slurry method), see, for example, Ullmann's Encyclopedia of Industrial Chemistry (Fifth, Completely Revised Edition, Volume A23; Editors Elvers et al., 290-292).

The non-crosslinked or significantly non-crosslinked butyl rubber polymer useful according to the present invention can have a Mooney viscosity (ASTM D 1646) ML (1+8@125° C.) in the range of from 25 to 65 units, for example, in the range of from 35 to 50 units.

As an example, the polymerization can be conducted in the presence of an inert aliphatic hydrocarbon diluent (such as n-hexane) and a catalyst mixture containing a major amount (in the range of from 80 to 99 mole percent) of a dialkylaluminum halide (for example diethylaluminum chloride), a minor amount (in the range of from 1 to 20 mole percent) of a monoalkylaluminum dihalide (for example isobutylaluminum dichloride), and a minor amount (in the range of from 0.01 to 10 ppm) of at least one of a member selected from the group comprising water, aluminoxane (for example methylaluminoxane) and mixtures thereof. Of course, other catalyst systems conventionally used to produce butyl polymers can be used to produce a butyl polymer which is useful herein, see, for example, “Cationic Polymerization of Olefins: A Critical Inventory” by Joseph P. Kennedy (John Wiley & Sons, Inc.© 1975, 10-12).

Polymerization may be performed both continuously and discontinuously. In the case of continuous operation, the process can be performed with the following feed streams:
I) solvent/diluent+isomonoolefin(s)+multiolefin(s)
II) catalyst

The continuous process is used in a commercial butyl rubber plant. In the case of discontinuous operation, the process may, for example, be performed as follows: The reactor, precooled to the reaction temperature, is charged with solvent or diluent and the monomers. The catalyst is then pumped in the form of a dilute solution in such a manner that the heat of polymerization may be dissipated without problem. The course of the reaction may be monitored by means of the evolution of heat.

The peroxide cured butyl composition of the present invention also includes a multiolefin cross-linking agent. Useful multiolefin cross-linking agent in the present invention can be a multiolefinic hydrocarbon compound. Examples of these include norbornadiene, 2-isopropenylnorbornene, 5-vinyl-2-norbornene, 1,3,5-hexatriene, 2-phenyl-1,3-butadiene, divinylbenzene, diisopropenylbenzene, divinyltoluene, divinylxylene or C₁ to C₂₀ alkyl-substituted derivatives of the above compounds. Or for example, the multiolefin crosslinking agent is divinylbenzene, diisopropenyl-benzene, divinyltoluene, divinylxylene or C₁ to C₂₀ alkyl substituted derivatives of said compounds. The multiolefin crosslinking agent can be divinylbenzene or diisopropenylbenzene.

The peroxide cured butyl compound of the present invention also includes at least one active or inactive filler. The filler may be:
highly dispersed silicas, prepared e.g., by the precipitation of silicate solutions or the flame hydrolysis of silicon halides, with specific surface areas of in the range of from 5 to 1000 m²/g, and with primary particle sizes of in the range of from 10 to 400 nm; the silicas can optionally also be present as mixed oxides with other metal oxides such as those of Al, Mg, Ca, Ba, Zn, Zr and Ti;
synthetic silicates, such as aluminum silicate and alkaline earth metal silicate like magnesium silicate or calcium silicate, with BET specific surface areas in the range of from 20 to 400 m²/g and primary particle diameters in the range of from 10 to 400 nm;
natural silicates, such as kaolin and other naturally occurring silica;
glass fibbers and glass fibber products (matting, extrudates) or glass microspheres;
metal oxides, such as zinc oxide, calcium oxide, magnesium oxide and aluminum oxide;
metal carbonates, such as magnesium carbonate, calcium carbonate and zinc carbonate;
metal hydroxides, e.g. aluminum hydroxide and magnesium hydroxide;
carbon blacks; the carbon blacks to be used here are prepared by the lamp black, furnace black or gas black process and have preferably BET (DIN 66 131) specific surface areas in the range of from 20 to 200 m²/g, e.g. SAF, ISAF, HAF, FEF or GPF carbon blacks;
rubber gels, especially those based on polybutadiene, butadiene/styrene copolymers, butadiene/acrylonitrile copolymers and polychloroprene;
   or mixtures thereof.

It might be advantageous to use a combination of carbon black and mineral filler in the present inventive compound. In this combination the ratio of mineral fillers to carbon black is usually in the range of from 0.05 to 20, or, for example, 0.1 to 10. For the rubber composition of the present invention it is usually advantageous to contain carbon black in an amount of in the range of from 20 to 200 parts by weight based on hundred parts of rubber, for example 30 to 150 parts by weight based on hundred parts of rubber, or, for example, 40 to 100 parts by weight based on hundred parts of rubber. Different types of carbon blacks and mineral fillers are described in several handbooks, e.g. various editions of “The Vanderbilt Rubber Handbook”.

The peroxide cured composition prepared according to the present invention further contains at least one peroxide curing system. The present invention is not limited to a special peroxide curing system. For example, inorganic or organic peroxides are suitable. For example, organic peroxides such as dialkylperoxides, ketalperoxides, aralkylperoxides, peroxide ethers, peroxide esters, such as di-tert.-butylperoxide, bis-(tert.-butylperoxyisopropyl)-benzene, dicumylperoxide, 2,5-dimethyl-2,5-di(tert.-butylperoxy)-hexane, 2,5-dimethyl-2,5-di(tert.-butylperoxy)-hexene-(3), 1,1-bis-(tert.-butyl peroxy)-3,3,5-trimethyl-cyclohexane, benzoylperoxide, tert.-butylcumylperoxide and tert.-butylperbenzoate. Usually the amount of peroxide in the compound is in the range of from 1 to 10 phr (=per hundred rubber), for example, from 4 to 8 phr. Subsequent curing is usually performed at a temperature in the range of from 100 to 200° C., for example 130 to 180° C. Peroxides might be applied advantageously in a polymer-bound form. Suitable systems are commercially available, such as Polydispersion T(VC) D-40 P from Rhein Chemie Rheinau GmbH, D (polymerbound di-tert.-butylperoxy-isopropylbenzene).

The composition may further contain other natural or synthetic rubbers such as BR (polybutadiene), ABR (butadiene/acrylic acid-C₁-C₄-alkylester-copolymers), CR (polychloroprene), IR (polyisoprene), SBR (styrene/butadiene-copolymers) with styrene contents in the range of 1 to 60 wt %, NBR (butadiene/acrylonitrile-copolymers with acrylonitrile contents of 5 to 60 wt %, HNBR (partially or totally hydrogenated NBR-rubber), EPDM (ethylene/propylene/diene-copolymers), FKM (fluoropolymers or fluororubbers), and mixtures of the given polymers.

The peroxide cured composition according to the present invention can contain further auxiliary products for rubbers, such as reaction accelerators, vulcanizing accelerators, vulcanizing acceleration auxiliaries, antioxidants, foaming agents, anti-aging agents, heat stabilizers, light stabilizers, ozone stabilizers, processing aids, plasticizers, tackifiers, blowing agents, dyestuffs, pigments, waxes, extenders, organic acids, inhibitors, metal oxides, and activators such as triethanolamine, polyethylene glycol, hexanetriol, etc., which are known to the rubber industry. The rubber aids are used in conventional amounts, which depend inter alia on the intended use. Conventional amounts are e.g. from 0.1 to 50 wt. %, based on butyl rubber. For example, the composition furthermore may contain in the range of 0.1 to 20 phr of an organic fatty acid, such as a unsaturated fatty acid having one, two or more carbon double bonds in the molecule which more preferably includes 10% by weight or more of a conjugated diene acid having at least one conjugated carbon-carbon double bond in its molecule. For example, those fatty acids have in the range of from 8-22 carbon atoms, or for example, 12-18. Examples include stearic acid, palmitic acid and oleic acid and their calcium-, zinc-, magnesium-, potassium- and ammonium salts.

The ingredients of the final peroxide cured butyl rubber composition are mixed together, suitably at an elevated temperature that may range from 25° C. to over 100° C. Normally the mixing time does not exceed one hour and a time in the range from 2 to 30 minutes is usually adequate. The mixing is suitably carried out in a suitable mixing means such as an internal mixer such as a Banbury mixer, or a Haake or Brabender miniature internal mixer. A two roll mill mixer also provides a good dispersion of the additives within the elastomer. An extruder also provides good mixing, and permits shorter mixing times. It is possible to carry out the mixing in two or more stages, and the mixing can be done in different apparatus, for example one stage in an internal mixer and one stage in an extruder. However, it should be taken care that no unwanted pre-crosslinking (=scorch) occurs during the mixing stage. For compounding and vulcanization see also, Encyclopedia of Polymer Science and Engineering, Vol. 4, p. 66 et seq. (Compounding) and Vol. 17, p. 666 et seq. (Vulcanization).

Preferably, the ingredients of the final peroxide cured butyl composition of the present invention are added to the mixer in one of the following two sequences:
I. non-crosslinked or significantly non-crosslinked butyl rubber polymer
II. filler(s) and crosslinking agent(s), wherein the crosslinking agent(s) is added in increments
III. peroxide curing agent
   Or
I. filler(s) and crosslinking agent(s), wherein the crosslinking agent(s) is added in increments
II. non-crosslinked or significantly non-crosslinked butyl rubber polymer
III. peroxide curing agent.

Furthermore, the present invention provides shaped articles containing the inventive peroxide-curable compound, which would then be vulcanized by heating it over the decomposition temperature of the peroxide and/or radiation. There are many applications for which said vulcanized and unvulcanized articles are suitable, such as containers for pharmaceuticals, in particular stopper and seals for glass or plastic vials, tubes, parts of syringes and bags for medical and non-medical applications, condenser caps and seals for fuel cells, parts of electronic equipment, in particular insulating parts, seals and parts of containers containing electrolytes, rings, dampening devices, ordinary seals, and sealants.

The present invention will be further illustrated by the following examples.

### EXAMPLES

The compounds presented in the examples employed the use of carbon black (IRB #7), divinylbenzene (ca. 63.5%, Dow Chemical) and peroxide (DI-CUP 40C, Struktol Canada Ltd.). Mixing was accomplished with the use of a miniature internal mixer (Brabender MIM) from C. W. Brabender, consisting of a drive unit (Plasticorder® Type PL-V151) and a data interface module.

Cure characteristics were determined with a Moving Die Rheometer (MDR) test carried out according to ASTM standard D-5289 on a Monsanto MDR 200 (E). The upper disc oscillated though a small arc of 1 degree.

Curing was achieved with the use of an Electric Press equipped with an Allan-Bradley Programmable Controller.

Stress-strain tests were carried out using an Instron Testmaster Automation System, Model 4464.

All of the inventive compounds studied were composed of:

| Polymer: | 90 or 85 | parts |
|---|---|---|
| Divinylbenzene: | 10 or 15 | parts |
| Carbon black (IRB #7; N330): | 50 | parts |
| Peroxide (DI-CUP 40 C): | 2 | parts |

Mixing was achieved with the use of a Brabender internal mixer (capacity ca. 75 g) with a starting temperature of 23° C. and a mixing speed of 50 rpm according to one of the two following sequences:

| 1) | |
|---|---|
| 0.0 min: | polymer added |
| 1.5 min: | carbon black added, with DVB, in |
| | increments |
| 7.0 min: | peroxide added |
| 8.0 min: | mix removed |

The final compound was refined on a 6″×12″ mill.

| 2) | |
|---|---|
| 0.0 min: | carbon black added with DVB, in |
| | increments |
| 1.5 min: | polymer added |
| 7.0 min: | peroxide added |
| 8.0 min: | mix removed |

The final compound was refined on a 6″×12″ mill.

### Example 1—Comparative

The compound was based on a commercial butyl rubber (Bayer Butyl 402, isobutylene content=97.8 mol %, isoprene content=2.2 mol %). No DVB was added in this case to the Brabender mixer.

The rubber (100 parts), carbon black (50 parts) and peroxide (3 parts) were mixed according to the sequence 1 presented above. As expected, no evidence of cure could be seen during the MDR test.

### Example 2—Comparative

The compound was based on a high isoprene butyl rubber prepared in the commercial facility of Bayer Inc. in Sarnia, Canada. The preparation method is described below (see also EP 1,449,859 A1).

The monomer feed composition was comprised of 4.40 wt. % of isoprene (IP or IC5) and 27.5 wt. % of isobutene (IP or IC4). This mixed feed was introduced into the continuous polymerization reactor at a rate of 5900 kg/hour. In addition, DVB was introduced into the reactor at a rate of 5.4 to 6 kg/hour. Polymerization was initiated via the introduction of an AlCl₃/MeCl solution (0.23 wt. % of AlCl₃ in MeCl) at a rate of 204 to 227 kg/hour. The internal temperature of the continuous reaction was maintained between −95 and −100° C. through the use of an evaporative cooling process. Following sufficient residence within the reactor, the newly formed polymer crumb was separated from the MeCl diluent with the use of an aqueous flash tank. At this point, ca. 1 wt. % of stearic acid was introduced into the polymer crumb. Prior to drying, 0.1 wt. % of Irganox® 1010 was added to the polymer. Drying of the resulting material was accomplished with the use of a conveyor oven.

The rubber had the isoprene content of 7.5 mol. %, Mooney viscosity (MU, ML1+8@125° C.) ca. 38 units and M_{w} about 800 kg/mol. This experimental high isoprene IIR elastomer contained trace amounts of DVB (ca. 0.07-0.11 mol. %) from its manufacturing process. This level is less than 10% of that found in commercial XL-10000 (ca. 1.2-1.3 mol. %). The gel content of this rubber was less than 5 wt. %. No DVB was added in this case to the Brabender mixer to prepare the rubber compound.

The rubber (100 parts), carbon black (50 parts) and peroxide (4 parts) were mixed according to the sequence 1 presented above. The cured compound gave the following test results: delta torque=2.15 dN·m, Shore A hardness=30 points, ultimate tensile=4.70 MPa, and ultimate elongation=998%.

Example 2 demonstrates that the high isoprene butyl rubber was more suitable for peroxide cure than the conventional butyl rubber.

### Example 3—Comparative

This compound was based on a commercial rubber (Bayer XL-10000). No DVB was added in this case to the Brabender mixer.

The rubber (100 parts), carbon black (50 parts) and peroxide (2 parts) were mixed according to the sequence 1 presented above.

The compound gave the following test results: delta torque=11.45 dN·m, Shore A hardness=57 points, ultimate tensile=4.86 MPa, and ultimate elongation=126%.

### Example 4—Invention

The compound was based on the high isoprene butyl rubber described in Example 2.

The rubber (90 parts), DVB (10 parts), carbon black (50 parts) and peroxide (2 parts) were mixed according to the sequence 2 presented above. The cured compound gave the following test results: delta torque=18.19 dN·m, Shore A hardness=58 points, ultimate tensile=5.84 MPa, and ultimate elongation=335%.

These results were better than those given in Example 3 for a condenser cap application.

### Example 5—Invention

This compound was based on the high isoprene butyl rubber described in Example 2.

The rubber (85 parts), DVB (15 parts), carbon black (50 parts) and peroxide (2 parts) were mixed according to the sequence 1 presented above. The cured compound gave the following test results: delta torque=39.90 dN·m, Shore A hardness=71 points, ultimate tensile=5.33 MPa, and ultimate elongation=229%.

These results demonstrate that using the present method it was possible to obtain a compound having a value of Shore A hardness above 70 points while the ultimate elongation was above 200%. At the same time, the ultimate tensile was similar or better than that for a reference compound based on XL-10000.

### Example 6—Invention

This compound was based on a commercial rubber (Bayer Butyl 301).

The rubber (85 parts), DVB (15 parts) carbon black (50 parts) and peroxide (2 parts) were mixed according to the sequence 1 presented above.

The compound gave the following test results: delta torque=13.84 dN·m, Shore A hardness=61 points, ultimate tensile=3.57 MPa, and ultimate elongation=987%.

The results are summarized in Table 1 and the MDR traces of the compounds are given in FIG. 1.

TABLE 1
Properties of Compounds 3-5.

| | System | | |
|---|---|---|---|
| | XL-10000 | High IP IIR + DVB | High IP IIR + DVB |
| Property | Example 3 | Example 4 | Example 5 |
| Hardness, | 57 | 58 | 71 |
| Shore A (pts.) | | | |
| Ultimate | 126 | 335 | 229 |
| Elongation (%) | | | |
| Ultimate Tensile | 4.86 | 5.84 | 5.33 |
| (MPa) | | | |
| Δ Torque (dNm) | 11.45 | 18.19 | 39.90 |

As illustrated by the following examples, compounds prepared with a totally soluble butyl rubber (RB 402) did not cure with peroxides alone, i.e. when DVB was absent in the rubber mix (Example 1). On the other hand, a significantly non-crosslinked high isoprene butyl rubber cured with peroxides alone (Example 2), but the cured properties (hardness, the ultimate elongation and delta torque) were considerably inferior compared to those referring to a comparative predominantly crosslinked butyl polymer, XL-10000 (Example 3). Also, compounds prepared according to the present inventive Example 4 and 5 (i.e. a significantly non-crosslinked butyl rubber which is mixed with a crosslinking agent, a filler, and a peroxide) had improved properties over those of XL-10000, making them superior to known butyl compounds in applications like condenser caps. Finally, a completely non-crosslinked butyl rubber compound according to the present invention (Example 6) had properties similar to the compound prepared based on Butyl XL10000.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for preparing a peroxide cured butyl composition comprising the steps of mixing a non-crosslinked or significantly non-crosslinked (<100 wt. % gel) butyl rubber polymer with a multiolefin crosslinking agent(s), a peroxide curing agent(s) and at least one filler, wherein the process does not comprise the addition of any non-peroxide curing agents.

2. The process according to claim 1, wherein the butyl polymer comprises the polymerization product of at least one C₄-C₇ isomonoolefin monomer and at least one C₄-C₁₄ multiolefin monomer, and optionally, one or more multiolefin crosslinking agent(s), wherein the multiolefin crosslinking agent(s) incorporated into the polymer is less than 0.15 mol %.

3. The process according to claim 1, wherein the multiolefin crosslinking agent is selected from the group consisting of norbornadiene, 2-isopropenylnorbornene, 5-vinyl-2-norbornene, 1,3,5-hexatriene, 2-phenyl-1,3-butadiene, divinylbenzene, diisopropenylbenzene, divinyltoluene, divinylxylene, a C₁ to C₂₀ alkyl-substituted derivatives thereof, or a mixture thereof.

4. The process according to claim 1, wherein the peroxide curing agent is dialkylperoxides, ketalperoxides, aralkylperoxides, peroxide ethers and peroxide esters.

5. The process according to claim 1, wherein the non-crosslinked or significantly non-crosslinked butyl rubber polymer has a gel content of less than 5 wt. % gel.

6. The process according to claim 4, wherein the peroxide curing agent is selected from the group consisting of di-tert.-butylperoxide, bis-(tert.-butylperoxyisopropyl)-benzene, dicumylperoxide, 2,5-dimethyl-2,5-di(tert.-butylperoxy)-hexane, 2,5-dimethyl-2,5-di(tert.-butylperoxy)-hexene-(3), 1,1-bis-(tert.-butylperoxy)-3,3,5-trimethyl-cyclohexane, benzoylperoxide, tert.-butylcumylperoxide and tert.-butylperbenzoate.

7. A composition prepared according to claim 1, comprising a non-crosslinked or significantly non-crosslinked (<10 wt. % gel) butyl rubber polymer, a multiolefin crosslinking agent, peroxides curing agent and at least one filler.

8. The composition according to claim 7, wherein the butyl polymer comprises the polymerization product of at least one C₄-C₇ isomonoolefin monomer and at least one C₄-C₁₄ multiolefin monomer, and optionally, one or more multiolefin crosslinking agent(s), the latter in amount of less than 0.15 mol. % in the polymer.

9. The composition according to claim 8, wherein the multiolefin crosslinking agent is selected from the group consisting of norbornadiene, 2-isopropenylnorbornene, 5-vinyl-2-norbornene, 1,3,5-hexatriene, 2-phenyl-1,3-butadiene, divinylbenzene, diisopropenylbenzene, divinyltoluene, divinylxylene, a C₁ to C₂₀ alkyl-substituted derivatives thereof, or a mixture thereof.

10. The composition according to claim 7, wherein the peroxide curing agent is dialkylperoxides, ketalperoxides, aralkylperoxides, peroxide ethers and peroxide esters.

11. The composition according to claim 10, wherein the peroxide curing agent is selected from the group consisting of di-tert.-butylperoxide, bis-(tert.-butylperoxyisopropyl)-benzene, dicumylperoxide, 2,5-dimethyl-2,5-di(tert.-butylperoxy)-hexane, 2,5-dimethyl-2,5-di(tert.-butylperoxy)-hexene-(3), 1,1-bis-(tert.-butylperoxy)-3,3,5-trimethyl-cyclohexane, benzoylperoxide, tert.-butylcumylperoxide and tert.-butylperbenzoate.
